(19) United States
(12) Patent Application Publication
(10) Pub. No.: US 2008/0102754 A1
(43) Pub. Date: May 1, 2008

(54) Automatic, Secure Identification and Parameterization of Coupled Automation Components via Near Field Communication

(75) Inventor: Gerhard Heinemann, Erlangen (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, Munchen (DE)

(21) Appl. No.: 11/720,054

(22) PCT Filed: Nov. 9, 2005
(86) PCT No.: PCT/EP05/55848

§ 371 Date: May 23, 2007

(30) Foreign Application Priority Data
Nov. 25, 2004 (DE) 10 2004 057 005.1

(51) Int. Cl. H04B 7/00

(52) U.S. Cl. 455/41.2

(57) ABSTRACT

Disclosed is an automatic, secure identification and parameterization of coupled automation components via close-range communication. Means for short-range communication are used in automation technology

Modern automated systems contain a multiplicity of interconnected automation components. These connections may be of an “intelligent” nature (Ethernet network, WLAN, Bluetooth, field bus, ISDN, etc.) or of a “primitive” nature (analog signals, binary terminal signals, motor feed line, network feed line, analog telephone line, etc.). In most cases, the interconnected components require information on one another, which is necessary for respective identification and adaptation. Today, this information can already be exchanged partially without problems, if, for example, a digital network with intelligent components and automatic address and topology recognition (e.g. Ethernet network) is present. However, in many cases this information exchange is not yet possible or is associated with inconvenient or error-prone commissioning steps.

Examples of intelligent connections are as follows:
In wireless networks such as Bluetooth and WLAN, information must be exchanged to indicate which of the automation components that can be contacted in a wireless manner are intended to work in a network and which are not. Corresponding authorization keys must be exchanged. These keys must currently be entered manually. The same applies to the codes for encrypting the information to be transmitted.
In field bus connections such as PROFIBUS, the addresses of the individual components must initially be allocated manually, e.g. via setting switches on the components.

Examples of unintelligent connections are as follows:
Motors without built-in intelligence (e.g. standard asynchronous motors) are connected only via their motor phases to the associated inverter. The inverter requires information on the motor in order to operate. This information can currently be determined only in part via identification methods built into the inverter (e.g. excitation of the motor with voltage pulses). Important, fundamental information, such as, for example, maximum permitted speed of rotation, number of poles and maximum permitted current of the motor must be specified manually.
The parameters of shaft encoders without built-in intelligence, such as, for example, the number of pulses, must currently be entered manually.

In addition, a multiplicity of further examples can be specified.

Insofar as this information must be entered manually, this initially gives rise to the problem of obtaining the correct data, e.g. by referring to current component data sheets. Input errors may then occur when these data are entered. Incorrect information results in protracted fault finding and, in the worst case, system damage or personal injury. Appropriately qualified personnel are therefore generally required for commissioning.

Further problems arise if mutually incompatible components are incorrectly interconnected. Examples of this are as follows:
Motors whose voltage range or operating principle does not match the inverter,
Transmitters with inappropriate signal or supply voltage levels.

Information which cannot be recorded automatically must currently be entered manually. To do this, the information is read from data sheets and is entered via commissioning devices (e.g. notebook as engineering system, PDA). Alternatively, the automation components contain lists with the data of the connectable components. In these cases, the commissioning party must select the respective connected components from this list. The problem with this is that the list stored in the automation component is frequently not up-to-date.

On this basis, the object of the invention is to make the handling of automation devices more user-friendly and secure.

This object is achieved by the inventions indicated in the independent patent claims. Advantageous designs are described in the dependent claims.

Accordingly, an industrial automation component has means for near field communication. Near field communication is a communication which is effected only over a distance of around 0 to 20 cm, in particular 0 to 5 cm and more preferably 0 to 1 cm, and no longer takes place over longer distances.

The invention makes use of the facilities of near field communication (NFC) to exchange the missing information. This involves a simple, low-cost, wireless communication which is restricted to a transmission path of a few centimeters. Due to the enforced proximity of the communicating components, unique allocation of these components to one another is required. This communication type functionally closes the existing gap between current, already fully intelligent, connections such as wired Ethernet and intelligent connections which still require manual inputs during commissioning, such as Bluetooth and WLAN. As NFC technology can communicate not only with active, but also with passive components such as very low-cost RF transponders and smart cards, the information from unintelligent components such as standard motors, contactors and simple sensors can also be transmitted herewith, insofar as these are equipped with appropriate components.
Near field communication technology is used in automation devices.
Near field communication is used to automatically activate wireless network connections between engineering systems and intelligent automation components.
Near field communication is used to read information from unintelligent automation components which are equipped with RF transponders into a data collection device (data logger) or an engineering system. An engineering system is used to interlink and process this information, e.g. in order to check the compatibility of the connected automation components.
Near field communication is used to transfer data from an engineering system or a data logger into an intelligent automation component.
Near field communication is used to read data from unintelligent components equipped with RF transponders into intelligent automation components.

A typical application is the connection of an engineering system to one or more automation components via a wireless network connection (e.g. WLAN or Bluetooth). Hitherto, this wireless communication initially had to be activated for this purpose, which, under certain circumstances, initially required the connection of a wired commissioning device to the automation component. This is unacceptable for the commissioning of a communications path which is only occasionally required. With the use of NFC, the engineering system only has to be moved briefly into the physical proximity of the automation components, whereby the WLAN or Bluetooth connection is automatically parameterized. Other components, which can similarly communicate via a WLAN and which are present on the factory premises, are not incorporated into the communications network; a unique authorization of the participants in the wireless communication is therefore possible.

In a further typical application, unintelligent components such as standard motors, contactors and simple sensors are equipped with very low-cost, passive RF transponders. An engineering system or a data logger, such as, for example, a PDA, is moved into the physical proximity of the components to be activated, so that a unique allocation is created. The relevant data of these unintelligent components can then be transferred into the engineering system or data logger with the aid of NFC. The engineering system or data logger is then moved into the physical proximity of the intelligent automation component to which the unintelligent components are intended to be connected. The data of the intelligent automation component are similarly read via the NFC interface into the engineering system. In the engineering system, the compatibility of the connected components can then be checked automatically; the read-in data of the unintelligent components can be transferred into the intelligent automation component, whereupon the latter adapts automatically to the connected components.

In a further typical application, an unintelligent component with an RF transponder is briefly held against the intelligent automation component to which it is intended to be connected during commissioning. The intelligent automation component automatically reads out the data from the RF transponder, without the aid of an engineering system, via its NFC interface and automatically adapts to the connected component. Near field communication technology can also replace the barcodes currently printed on automation components. The advantage of near field communication technology is the practically unlimited quantity of information and the possibility in principle of also transferring data back into the component.

1.-8. (canceled)

9. An automation system comprising at least two automation components which communicate with one another by means of near field communication over a signal transmission path having a length in a range of 0-20 cm, wherein a first of the at least two automation components transfers parameterization information to a second of the at least two automation components by means of the near field signal transmission path.

10. The automation system of claim 9, wherein the first automation component is an engineering system of the automation system.

11. The automation system of claim 9, wherein the signal transmission path comprises a WLAN connection.

12. The automation system of claim 9, wherein the signal transmission path comprises a Bluetooth connection.

13. An automation system comprising at least two automation components which communicate with one another by means of near field communication over a signal transmission path having a length in a range of 0-20 cm, wherein a first of the at least two automation components is an engineering system of the automation components, and a second of the at least two automation components comprises a motor with an RF transponder having a memory, wherein data transferred from the second automation component to the first automation component over the transmission path are stored in the memory of the RF transponder, said data comprising at least one datum selected from the group consisting of a maximum permitted rotation speed of the motor, a number of poles of the motor, a maximum permitted current of the motor, and number of items.

14. The automation system of claim 13, wherein the signal transmission path comprises a WLAN connection.

15. The automation system of claim 13, wherein the signal transmission path comprises a Bluetooth connection.
